(19) United States
(12) Patent Application Publication
(10) Pub. No.: US 2024/0351465 A1
(43) Pub. Date: Oct. 24, 2024

(54) ELECTRIFIED FIRE FIGHTING VEHICLE SYSTEM

(71) Applicant: Oshkosh Corporation, Oshkosh, WI (US)

(72) Inventors: Eric Linsmeier, Larsen, WI (US); Jake Klaameyer, Oshkosh, WI (US); Chad Smith, Omro, WI (US)

(73) Assignee: Oshkosh Corporation, Oshkosh, WI (US)

(21) Appl. No.: 18/636,974

(22) Filed: Apr. 16, 2024

Related U.S. Application Data
(60) Provisional application No. 63/461,160, filed on Apr. 21, 2023.
(60) Provisional application No. 63/551,940, filed on Feb. 9, 2024.

(51) Int. Cl. B60L 53/63; A62C 27/00; B60L 53/66; B60L 53/68

(52) U.S. Cl. CPC B60L 53/63; B60L 53/665; B60L 53/68; A62C 27/00

(57) ABSTRACT

A charge management system includes one or more processing circuits. The one or more processing circuits include one or more memory devices coupled to one or more processors. The one or more memory devices are configured to store instructions thereon that, when executed by the one or more processors, cause the one or more processors to receive an indication regarding an electrified fire apparatus being connected to a charging station, determine a charge readiness score for the electrified fire apparatus, and provide a charge management function by transmitting a signal to at least one of the charging station or the electrified fire apparatus to prevent charging from starting, stop charging if already charging, start charging if not already charging, or continue charging if already charging based on the charge readiness score.

### CROSS-REFERENCE TO RELATED PATENT APPLICATIONS

This application claims the benefit of and priority to U.S. Provisional Patent Application No. 63/461,160, filed Apr. 21, 2023, and U.S. Provisional Patent Application No. 63/551,940, filed Feb. 9, 2024, both of which are incorporated herein by reference in their entireties.

### BACKGROUND

Costs associated with charging electrified vehicles can shift drastically throughout the day based on demand on the power grid. If an electrified vehicle is plugged in at peak hours, it can cost significantly more to charge the electrified vehicle than at off or non-peak hours.

### SUMMARY

One embodiment relates to a charge management system. The charge management system includes one or more processing circuits. The one or more processing circuits include one or more memory devices coupled to one or more processors. The one or more memory devices are configured to store instructions thereon that, when executed by the one or more processors, cause the one or more processors to receive an indication regarding an electrified fire apparatus being connected to a charging station, determine a charge readiness score for the electrified fire apparatus, and provide a charge management function by transmitting a signal to at least one of the charging station or the electrified fire apparatus to prevent charging from starting, stop charging if already charging, start charging if not already charging, or continue charging if already charging based on the charge readiness score.

Another embodiment relates to a charge management system. The charge management system includes one or more processing circuits. The one or more processing circuits include one or more memory devices coupled to one or more processors. The one or more memory devices are configured to store instructions thereon that, when executed by the one or more processors, cause the one or more processors to receive indications regarding one or more electrified fire apparatuses associated with a fire station being connected to one or more charging stations at the fire station and maintain the one or more electrified fire apparatuses sufficiently charged and ready to be dispatched while reducing operating costs for the fire station.

Still another embodiment relates to a charge management system. The charge management system includes one or more processing circuits. The one or more processing circuits include one or more memory devices coupled to one or more processors. The one or more memory devices are configured to store instructions thereon that, when executed by the one or more processors, cause the one or more processors to receive a first indication regarding a first electrified fire apparatus being connected to a first charging station at a fire station, receive a second indication regarding a second electrified fire apparatus being connected to a second charging station at the fire station, and provide a charge management function by (a) transmitting a first signal to at least one of the first charging station or the first electrified fire apparatus and (b) transmitting a second signal to at least one of the second charging station or the second electrified fire apparatus. Each of the first signal and the second signal either prevents charging from starting, stops charging if already charging, starts charging if not already charging, or continues charging if already charging. The first signal and the second signal are based on (a) a fire station response history profile for the fire station, (b) a current cost of electricity at the fire station, (c) an expected future cost of electricity at the fire station, (d) a first current state of charge of the first electrified fire apparatus, and (e) a second current state of charge of the second electrified fire apparatus.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a front, left perspective view of an electrified fire fighting vehicle, according to an exemplary embodiment.

FIG. 1B is a side view of the electrified fire fighting vehicle of FIG. 1A with an aerial ladder assembly, according to an exemplary embodiment.

FIG. 2 is a schematic block diagram of a fleet of electrified fire fighting vehicles, according to an exemplary embodiment.

FIG. 3 is a schematic diagram of a control system for the fleet of electrified fire fighting vehicles of FIG. 2, according to an exemplary embodiment.

FIG. 4 is a graphical user interface displaying an impact of ownership tool, according to an exemplary embodiment.

FIG. 5 is a first graph output by the impact of ownership tool of FIG. 4 showing energy costs over time, according to an exemplary embodiment.

FIG. 6 is a second graph output by the impact of ownership tool of FIG. 4 showing lifetime energy costs and CO₂e emissions, according to an exemplary embodiment.

FIG. 7 is a graphical user interface displaying a charger sizing tool, according to an exemplary embodiment.

FIG. 8 is a graphical user interface displaying a charge management tool, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle

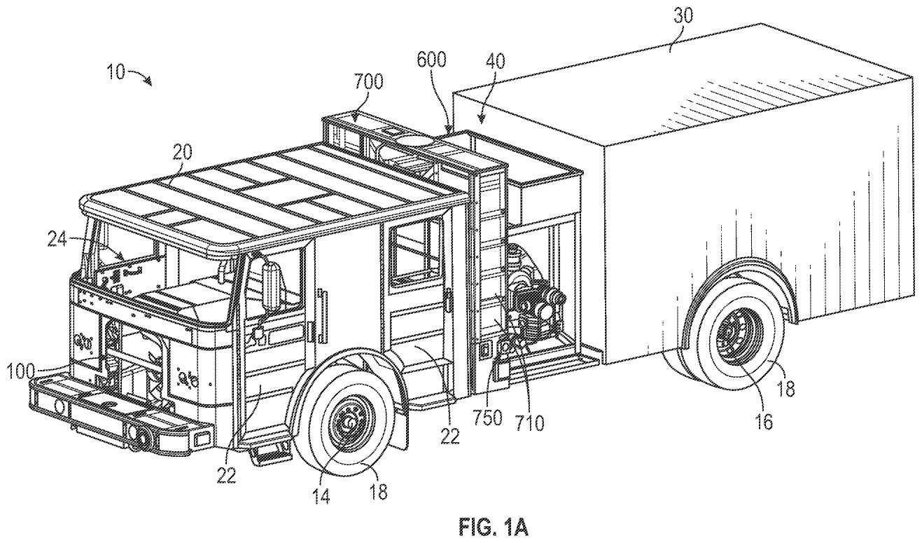

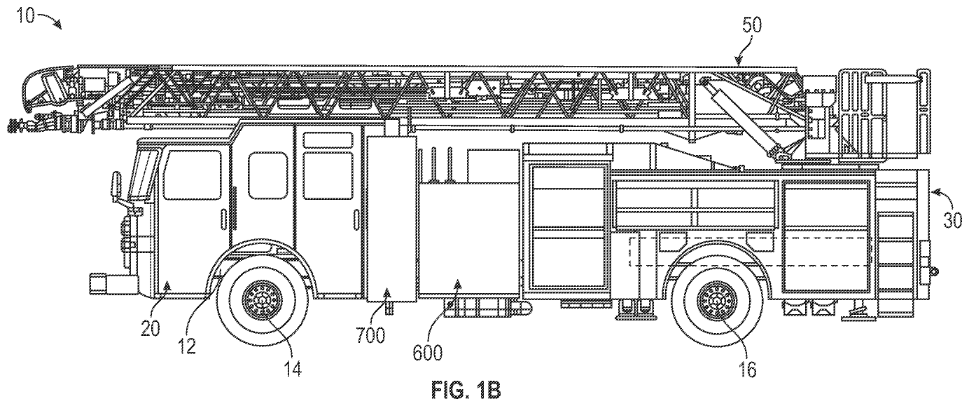

According to the exemplary embodiment shown in FIGS. 1A and 1B, a machine, shown vehicle 10, is configured as a fire fighting vehicle. In the embodiment shown in FIG. 1A, the fire fighting vehicle is a pumper fire truck. In the embodiment shown in FIG. 1B, the fire fighting vehicle is an aerial ladder truck. The aerial ladder truck may include a rear-mount aerial ladder or a mid-mount aerial ladder. In some embodiments, the aerial ladder truck is a quint fire truck. In other embodiments, the aerial ladder truck is a tiller fire truck. In still another embodiment, the fire fighting vehicle is an airport rescue fire fighting (“ARFF”) truck. In various embodiments, the fire fighting vehicle (e.g., a quint, a pumper, a tanker, an ARFF, etc.) includes an on-board water storage tank, an on-board agent storage tank, and/or a pumping system. In other embodiments, the fire fighting vehicle is still another type of fire fighting vehicle. In an alternative embodiment, the vehicle 10 is another type of vehicle other than a fire fighting vehicle. For example, the vehicle 10 may be a refuse truck, a concrete mixer truck, a military vehicle, a tow truck, an ambulance, a farming/agriculture machine or vehicle, a construction machine or vehicle, airport ground service equipment (e.g., a tractor, a loader, a de-icer truck, etc.), and/or still another vehicle or machine.

As shown in FIGS. 1A and 1B, the vehicle 10 includes a chassis, shown as frame 12; a plurality of axles, shown as front axle 14 and rear axle 16, supported by the frame 12 and that couple a plurality of tractive elements, shown as wheels 18, to the frame 12; a cab, shown as front cabin 20, supported by the frame 12; a body assembly, shown as a rear section 30, supported by the frame 12 and positioned rearward of the front cabin 20; and a driveline (e.g., a powertrain, a drivetrain, an accessory drive, a prime mover, an electric driveline including one or more motors, a hybrid driveline including an engine and one or more motors, a non-hybrid, dual-drive driveline including an engine and one or more motors etc.), shown as driveline 100. While shown as including a single front axle 14 and a single rear axle 16, in other embodiments, the vehicle 10 includes two front axles 14 and/or two rear axles 16. In an alternative embodiment, the tractive elements are otherwise structured (e.g., tracks, etc.).

According to an exemplary embodiment, the front cabin 20 includes a plurality of body panels coupled to a support (e.g., a structural frame assembly, etc.). The body panels may define a plurality of openings through which an operator accesses an interior 24 of the front cabin 20 (e.g., for ingress, for egress, to retrieve components from within, etc.). As shown in FIGS. 1A and 1B, the front cabin 20 includes a plurality of doors, shown as doors 22, positioned over the plurality of openings defined by the plurality of body panels. The doors 22 may provide access to the interior 24 of the front cabin 20 for a driver and/or passengers of the vehicle 10. The doors 22 may be hinged, sliding, or bus-style folding doors.

The front cabin 20 may include components arranged in various configurations. Such configurations may vary based on the particular application of the vehicle 10, customer requirements, or still other factors. The front cabin 20 may be configured to contain or otherwise support a number of occupants, storage units, and/or equipment. For example, the front cabin 20 may provide seating for an operator (e.g., a driver, etc.) and/or one or more passengers of the vehicle 10. The front cabin 20 may include one or more storage areas for providing compartmental storage for various articles (e.g., supplies, instrumentation, equipment, etc.). The interior 24 of the front cabin 20 may further include a user interface. The user interface may include a cabin display and various controls (e.g., buttons, switches, knobs, levers, joysticks, etc.). In some embodiments, the user interface within the interior 24 of the front cabin 20 further includes touchscreens, a steering wheel, an accelerator pedal, and/or a brake pedal, among other components. The user interface may provide the operator with control capabilities over the vehicle 10 (e.g., direction of travel, speed, etc.), one or more components of driveline 100, and/or still other components of the vehicle 10 from within the front cabin 20.

In some embodiments, the rear section 30 includes a plurality of compartments with corresponding doors positioned along one or more sides (e.g., a left side, right side, etc.) and/or a rear of the rear section 30. The plurality of compartments may facilitate storing various equipment such as oxygen tanks, hoses, axes, extinguishers, ladders, chains, ropes, straps, boots, jackets, blankets, first-aid kits, and/or still other equipment. One or more of the plurality of compartments may include various storage apparatuses (e.g., shelving, hooks, racks, etc.) for storing and organizing the equipment.

In some embodiments (e.g., when the vehicle 10 is an aerial ladder truck, etc.), as shown in FIG. 1B, the rear section 30 includes an aerial ladder assembly, shown as aerial ladder 50. The aerial ladder 50 may have a fixed length or may have one or more extensible ladder sections. The aerial ladder 50 may include a basket or implement (e.g., a water turret, etc.) coupled to a distal or free end thereof. According to the exemplary embodiment shown in FIG. 1B, the aerial ladder 50 is coupled to the frame 12 proximate a rear of the rear section 30 (e.g., a rear-mount fire truck). In some embodiments, the aerial ladder 50 is coupled to the frame 12 proximate a front of the rear section 30 (e.g., a mid-mount fire truck).

In some embodiments (e.g., when the vehicle 10 is an ARFF truck, a pumper truck, a tanker truck, a quint truck, etc.), the rear section 30 includes one or more fluid tanks. By way of example, the one or more fluid tanks may include a water tank and/or an agent tank. The water tank and/or the agent tank may be corrosion and UV resistant polypropylene tanks. In a municipal fire truck implementation (i.e., a non-ARFF truck implementation), the water tank may have a maximum water capacity ranging between 50 and 1000 gallons (e.g., 50, 100, 150, 200, 250, 300, 350, 400, 450, 500, 550, 600, 650, 700, 750, 800, 850, 900, 950, 1000, etc. gallons). In an ARRF truck implementation, the water tank may have a maximum water capacity ranging between 1,000 and 4,500 gallons (e.g., at least 1,250 gallons; between 2,500 gallons and 3,500 gallons; at most 4,500 gallons; at most 3,000 gallons; at most 1,500 gallons; etc.). The agent tank may have a maximum agent capacity ranging between 25 and 750 gallons (e.g., 25, 50, 75, 100, 150, 200, 250, 300, 350, 400, 450, 500, 550, 600, 650, 700, 750, etc. gallons). According to an exemplary embodiment, the agent is a foam fire suppressant, an aqueous film forming foam (“AFFF”). A low-expansion foam, a medium-expansion foam, a high-expansion foam, an alcohol-resistant foam, a synthetic foam, a protein-based foams, a fluorine-free foam, a film-forming fluoro protein (“FFFP”) foam, an alcohol resistant aqueous film forming foam (“AR-AFFF”), and/or still another suitable foam or a foam yet to be developed. The capacity of the water tank and/or the agent tank may be specified by a customer. It should be understood that water tank and the agent tank configurations are highly customizable, and the scope of the present disclosure is not limited to a particular size or configuration of the water tank and the agent tank.

According to an exemplary embodiment, the driveline 100 includes one or more electric motors configured to drive the front axle 14 and/or the rear axle 16. In some embodiments, the driveline 100 includes an engine to supplement the one or more electric motors. Accordingly, the driveline 100 may be an all-electric driveline, a hybrid driveline, and/or a dual-drive driveline.

As shown in FIGS. 1A and 1B, the vehicle 10 includes a pump assembly, shown as pump system 600, coupled to the frame 12 and positioned between the front cabin 20 and the rear section 30. In other embodiments, the pump system 60 is otherwise positioned (e.g., within the rear section 30). As shown in FIGS. 1A and 1B, the vehicle 10 includes an on-board energy storage system (“ESS”), shown as ESS 700, coupled to the frame 12 and positioned between the front cabin 20 and the rear section 30. In other embodiments, the ESS 700 is otherwise positioned (e.g., within the rear section 30, under the front cabin 20, under the rear section 30, etc.). According to an exemplary embodiment, the ESS 700 is configured to power the one or more electric motors of the driveline 100. As shown in FIG. 1A, the ESS 700 includes one or more battery packs, shown as battery packs 710, and a charging system, shown as high voltage charging system 750. According to an exemplary embodiment, the high voltage charging system 750 includes a charging port that facilities selectively, electrically coupling the battery packs 710 to an external power source (e.g., a charging station, etc.). Further details regarding the vehicle 10 may be found in U.S. Patent Publication No. 2022/0355141, filed Apr. 26, 2022, U.S. patent application Ser. No. 18/501,424, filed Nov. 3, 2023, both of which are incorporated herein by reference in their entireties.

### Vehicle Fleet

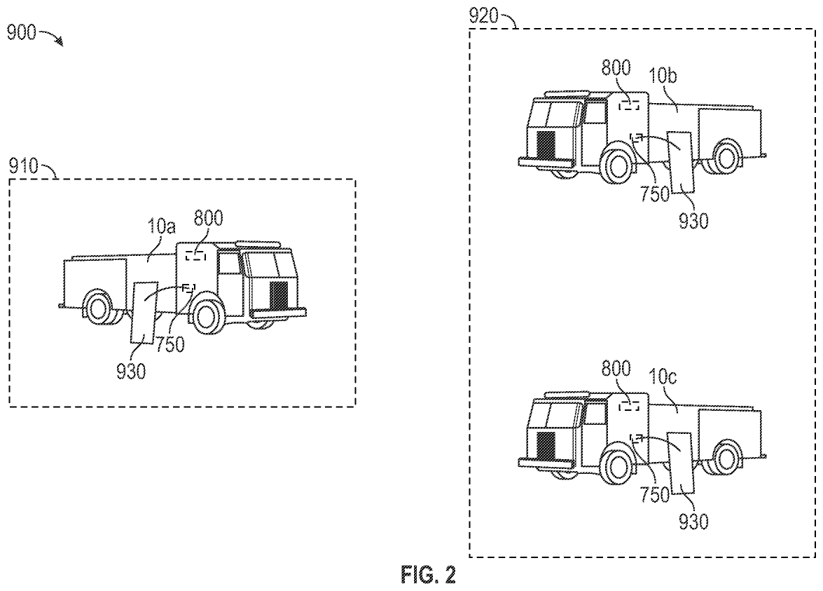

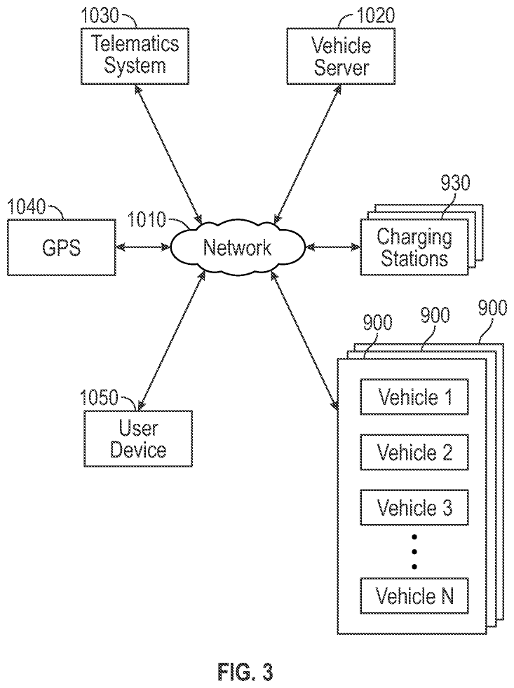

As shown in FIGS. 2 and 3, a fleet, shown as vehicle fleet 900, includes a plurality of vehicles, shown as vehicle 10a, vehicle 10b, vehicle 10c, . . . , and vehicle 10n. The vehicle 10a, the vehicle 10b, the vehicle 10c, . . . , and the vehicle 10n may be the same or similar to the vehicle 10. Accordingly, the vehicles 10, as used herein, may refer to the vehicle 10a, the vehicle 10b, the vehicle 10c, . . . , and the vehicle 10n. As shown in FIG. 2, the vehicles 10 include an on-board control system, shown as vehicle controller 800.

According to an exemplary embodiment, the vehicles 10 in the vehicle fleet 900 are associated with a respective fire department. As shown in FIG. 2, the vehicles 10 of the vehicle fleet 900 are dispersed or distributed between a first location, shown location 910, and a second location, shown as location 920. By way of example, the location 910 may be a first fire station (fire station A) that is part of the respective fire department and is associated with or that services a first area or district in a respective city, municipality, county, town, village, etc. and the location 920 may be a second fire station (fire station B) that is part of the respective fire department and is associated with or that services a second area or district in the respective city, municipality, county, town, village, etc. In some embodiments, the vehicles 10 are dispersed or distributed between more than two locations (e.g., in a larger city, county, municipality, etc.). In some embodiments, the vehicles 10 are centrally located at a single location (e.g., in a smaller city, county, municipality, town, village, etc.).

As shown in FIG. 2, each of the location 910 and the location 920 includes one or more external power sources, shown as charging stations 930. According to an exemplary embodiment, the charging stations 930 are configured to electrically couple to the ESS 700 of the vehicles 10 via the high voltage charging system 750 of the ESS 700 to facilitate charging the battery packs 710 of the ESS 700.

### Vehicle Evaluation, Charging, and Optimization System

As shown in FIG. 3, a vehicle system, shown as vehicle evaluation, charging, and optimization system 1000, includes one or more vehicle fleets 900, one or more charging stations 930, a network (e.g., the Internet, etc.), shown as network 1010, a remote server, shown as vehicle server 1020, a first external system, shown as telematics system 1030, a second external system, shown as global positioning system (“GPS”) 1040, and a user access device, shown user device 1050.

According to the exemplary embodiment, the vehicle controllers 800 and/or the vehicle server 1020 are implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment, the vehicle controllers 800 and/or the vehicle server 1020 include a processing circuit and a memory. The processing circuit may include an ASIC, one or more FPGAs, a DSP, circuits containing one or more processing components, circuitry for supporting a microprocessor, a group of processing components, or other suitable electronic processing components. In some embodiments, the processing circuit is configured to execute computer code stored in the memory to facilitate the activities described herein. The memory may be any volatile or non-volatile computer-readable storage medium capable of storing data or computer code relating to the activities described herein. According to an exemplary embodiment, the memory includes computer code modules (e.g., executable code, object code, source code, script code, machine code, etc.) configured for execution by the processing circuit. In some embodiments, the vehicle controllers 800 and/or the vehicle server 1020 represent a collection of processing devices. In such cases, the processing circuit represents the collective processors of the devices, and the memory represents the collective storage devices of the devices.

The telematics system 1030 may be a server-based system that monitors various telematics information and provides telematics data based on the telematics information to the vehicle server 1020 and/or the vehicle controllers 800 over the network 1010. The GPS 1040 may similarly be a server-based system that monitors various GPS information and provides GPS data based on the GPS information to the vehicle server 1020 and/or the vehicle controllers 800 over the network 1010. In some embodiments, the telematics system 1030 and the GPS 1040 are integrated into a single system. The telematics data may include electricity costs at each of the locations of the vehicles 10. The GPS data may include an indication of a current location of the vehicle 10. The GPS data and/or the telematics data may additionally or alternatively include travel history details regarding scene responses of each of the vehicles 10 and/or for vehicles leaving a certain location (e.g., the location 910 versus the location 920). By way of example, the travel history details may include specific route information, time information, frequency of response information, and/or still other information. The vehicle controllers 800 of the vehicles 10 may be configured to acquire and provide vehicle data to the vehicle server 1020 over the network 1010. The vehicle data may include information about the current state of charge (“SOC”) of the ESS 700 of a respective vehicle 10 and/or the current state of health (“SOH”) of components of the respective vehicle (e.g., the ESS 700, the pump system 600, etc.).

The user device 1050 may be any suitable device that facilitates user access to the vehicle server 1020, the vehicle controller 800 of the vehicles 10, the telematics system 1030, and/or the GPS 1040 over the network 1010. By way of example, the user device 1050 may be or include a personal electronic device, a computer (e.g., a laptop computer, a desktop computer, etc.), a tablet, a smart phone, and/or another electronic device. As described in greater herein, the user device 1050 may be configured to facilitate accessing a user portal through which (a) various tools and/or information may be accessed by a user and/or (b) user entered data can be input.

According to an exemplary embodiment, the vehicle server 1020 is configured to communicate with the vehicles 10 of the one or more vehicle fleets 900, the charging stations 930, the telematics system 1030, the GPS 1040, and/or the user device 1050 over the network 1010 to (1) receive or acquire (a) the vehicle data from the vehicles 10, (b) the telematics data from the telematics system 1030, (c) the GPS data from the GPS 1040, and/or (d) the user entered data from the user device 1050 and/or (2) control the vehicles 10 and/or the charging stations 930 to dynamically modulate charging of the vehicles 10. In some embodiments, a respective vehicle controller 800 is configured to acquire the telematics data for the vehicle 10 associated therewith from the telematics system 1030 and/or the GPS data for the vehicle 10 associated therewith from the GPS 1040, and then the respective vehicle controller 800 is configured to transmit the vehicle data, the telematics data, and/or the GPS data associated with the vehicle 10 to the vehicle server 1020 (e.g., as a single vehicle profile for the vehicle 10). As described in greater detail herein, the vehicle server 1020 (and/or the vehicle controller 800) is configured to facilitate (a) evaluating the impact (e.g., cost, emissions, etc.) of ownership of an electric variant versus an equivalent internal combustion engine (“ICE”) variant of the vehicle 10, (b) evaluating charger sizes to identify a suitable charge for the vehicle 10 based on individual department needs, and (c) intelligently evaluating vehicle charging and performance requirements to facilitate dynamic charging management to minimize or optimize cost of ownership.

It should be understood that, while certain functionality may be described herein in the context of the vehicle server 1020, such functionality may be performed or conducted by the combination of the vehicle server 1020 and the vehicle controllers 800, or locally with just the vehicle controllers 800 (e.g., local communication between vehicles 10 at a respective location).

### Impact of Ownership Tool

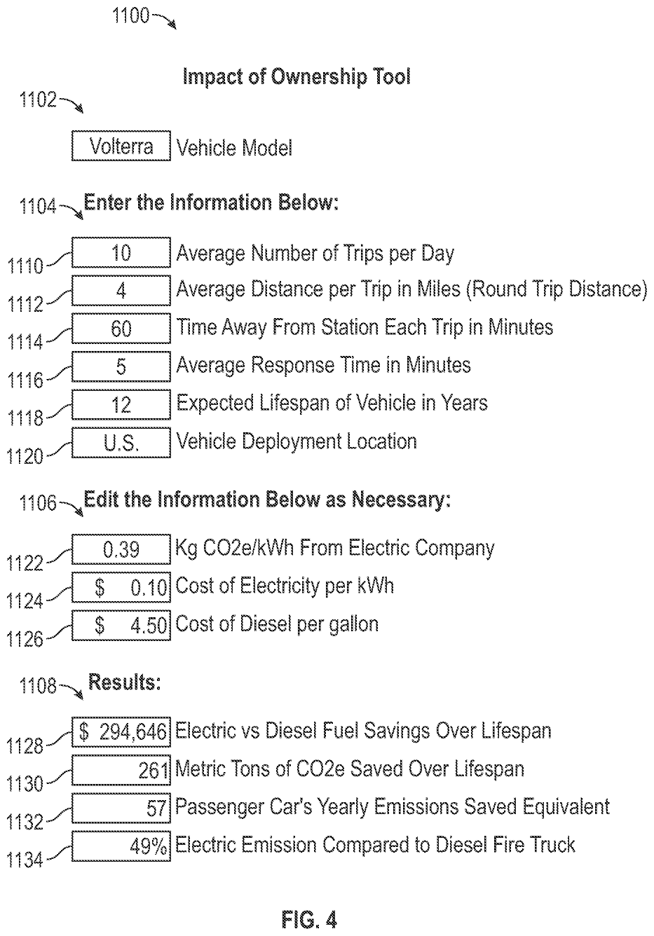

As shown in FIG. 4, the vehicle server 1020 (and/or the vehicle controller 800) is configured to facilitate accessing a first tool, shown as impact of ownership tool 1100, with the user device 1050 and/or the user interface of the vehicle 10. According to an exemplary embodiment, the impact of ownership tool 1100 facilitates evaluating the impact (e.g., cost, emissions, etc.) of ownership of an electric variant versus an ICE variant of the vehicle 10. As shown in FIG. 4, the impact of ownership tool 1100 provides a graphical user interface having a first portion or section, shown as vehicle model section 1102, a second portion or section, shown as department response information section 1104, a third section, shown as cost section 1106, and a fourth section, shown as results section 1108.

According to an exemplary embodiment, the vehicle model section 1102 facilitates entering or selecting (e.g., from a drop-down menu) a model of the vehicle 10 owned by a user or a model of the vehicle 10 for which a user desires to run analytical models for (e.g., prior to ordering the vehicle 10). By way of example, the models may include the Pierce® Volterra™ municipal pumper fire apparatus, the Pierce® Volterra™ municipal aerial fire apparatus, the Oshkosh® Striker® Volterra™ ARFF vehicle, and/or other vehicle models. In some embodiments, the vehicle model section 1102 facilitates entering other inputs such manufacture year, vehicle generation, VIN number, etc. to more closely tailor the results of the impact of ownership tool 1100 to the specific vehicle of interest. In some embodiments, the impact of ownership tool 1100 is associated with a single vehicle model (i.e., a vehicle specific tool) and, therefore, does not include the vehicle model section 1102. In such embodiments, multiple separate impact of ownership tools 1100 may be designed (e.g., built, coded, etc.) and accessed for each respective vehicle.

According to an exemplary embodiment, the department response information section 1104 facilitates entering or selecting (e.g., from drop-down menus) various information associated with average response parameters or response requirements for a respective department. As shown in FIG. 4, the department response information section 1104 includes a first input area, interface, or cell, shown as average number of trips box 1110, that facilitates entering or selecting an average number of trips taken per day by a vehicle of the department; a second input area, interface, or cell, shown as average distance box 1112, that facilitates entering or selecting an average round trip distance (e.g., in miles) per trip taken by the vehicle of the department; a third input area, interface, or cell, shown as average time away box 1114, that facilitates entering or selecting an average time (e.g., in minutes) the vehicle is away from the station for each trip taken by the vehicle of the department; a fourth input area, interface, or cell, shown as average response time box 1116, that facilitates entering or selecting an average time (e.g., in minutes) it takes the vehicle to respond to a scene; a fifth input area, interface, or cell, shown as expected lifespan box 1118, that facilitates entering or selecting a lifespan (e.g., in years) that is expected of the vehicle by the department; and a sixth input area, interface, or cell, shown as location box 1120, that facilitates entering or selecting a location (e.g., country, state, county, city, etc.) at which the department is located and the vehicle is or will be deployed. While described as being input by a user with the user device 1050, in some embodiments, the impact of ownership tool 1100 automatically populates at least a portion of the information into the department response information section 1104 based on the telematics data, the GPS data, and/or the vehicle data for a respective vehicle 10 (e.g., if in service already) or other vehicles already being operated by the department.

As shown in FIG. 4, the cost section 1106 includes a seventh input area, interface, or cell, shown as CO₂e emission intensity box 1122, associated with a CO₂e emission intensity (i.e., a ratio of CO₂e emissions from public electricity production and gross electricity production) at the deployment location of the vehicle; an eighth input area, interface, or cell, shown as electricity cost box 1124, associated with a current (average) cost per kilowatt-hour of electricity at the deployment location of the vehicle; and a ninth input area, interface, or cell, shown as fuel cost box 1126, associated with a current (average) cost per gallon of fuel (e.g., diesel) at the deployment location of the vehicle. According to an exemplary embodiment, the impact of ownership tool 1100 automatically populates information or data into the CO₂e emission intensity box 1122, the electricity cost box 1124, and/or the fuel cost box 1126 based on the information entered into or selected at the location box 1120. Such information or data automatically populated by the impact of ownership tool 1100 may be sourced from a database, an electricity provider's website, sustainability reports, and/or other sources. In some embodiments, the user can manually override the information automatically populated and enter user preferred values.

According to an exemplary embodiment, the results section 1108 facilitates displaying various results or outputs based on the data, information, etc. input and/or populated into the vehicle model section 1102, the department response information section 1104, and/or the cost section 1106. As shown in FIG. 4, the results section 1108 includes a first output area or cell, shown as energy cost savings box 1128, a second output area or cell, shown as CO₂e savings box 1130, a third output area or cell, shown as passenger car equivalent box 1132, and a fourth output area or cell, shown as electric vs. ICE emissions box 1134. The energy cost savings box 1128 provides a projected energy cost savings (e.g., in dollars) over the lifespan of the vehicle 10 by owning and operating the vehicle 10 rather than an equivalent ICE variant thereof. Such value may be estimated based on the projected electricity usage over the lifespan of the vehicle 10 versus the projected fuel usage (e.g., diesel) of the equivalent ICE variant thereof over the same lifespan. Energy cost inflation may be accounted for by utilizing historical data from the Energy Information Administration (“EIA”) (e.g., from 1994 to present). Based on such historical data, this calculation may assume a first inflation rate (e.g., 2%) for electricity costs and a second inflation rate (e.g., 8%) for diesel fuel year-over-year. The CO₂e savings box 1130 provides a projected CO₂e emissions savings (e.g., in metric tons) over the lifespan of the vehicle 10 by owning and operating the vehicle 10 rather than an equivalent ICE variant thereof. To be conservative, such value may be estimated using a static value for emissions generated by electricity producers per kWh because electricity producers are continuing to increase energy production using renewable, non-CO₂ emitting sources (e.g., solar, wind, hydro, etc.). The passenger car equivalent box 1132 provides a projected emissions savings provided by the vehicle 10 in units of passenger cars' yearly emissions. Such comparison assumes the average yearly emissions for ICE passenger vehicles. The electric vs. ICE emissions box 1134 provides a projected amount or percentage of emission generated by the vehicle 10 over the lifespan of the vehicle 10 relative to an equivalent ICE variant thereof.

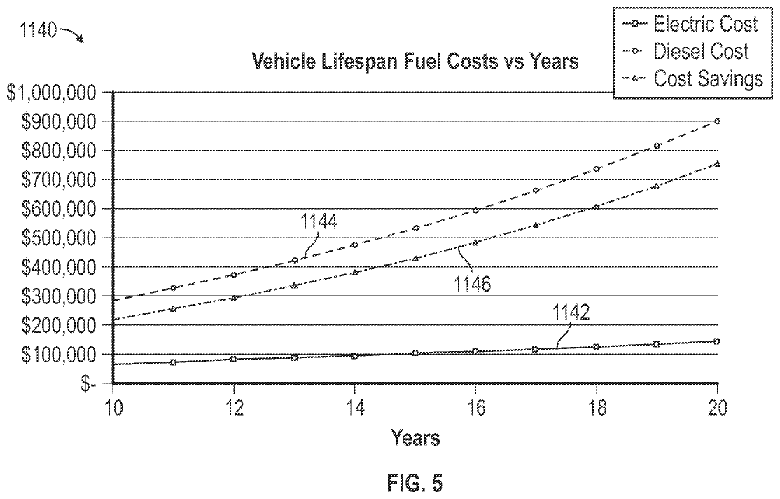

As shown in FIG. 5, the impact of ownership tool 1100 is configured to generate and provide a first graph output, shown as energy costs over time graph 1140, based on the inputs and outputs of the vehicle model section 1102, the department response information section 1104, the cost section 1106, and/or the results section 1108. The energy costs over time graph 1140 provides a first visual or graphical element, shown as electricity cost curve 1142, a second visual or graphical element, shown as fuel cost curve 1144, and a third visual or graphical element, shown as costs savings curve 1146. The electricity cost curve 1142 provides a visual projection of the total electricity cost to operate the vehicle 10 over the lifespan of the vehicle 10. The fuel cost curve 1144 provides a visual projection of the total fuel cost to operate an equivalent ICE variant of the vehicle 10 over the lifespan thereof. The costs savings curve 1146 provides a visual projection of the total energy cost savings from owning and operating the vehicle 10 relative to an equivalent ICE variant of the vehicle 10 over the lifespans thereof.

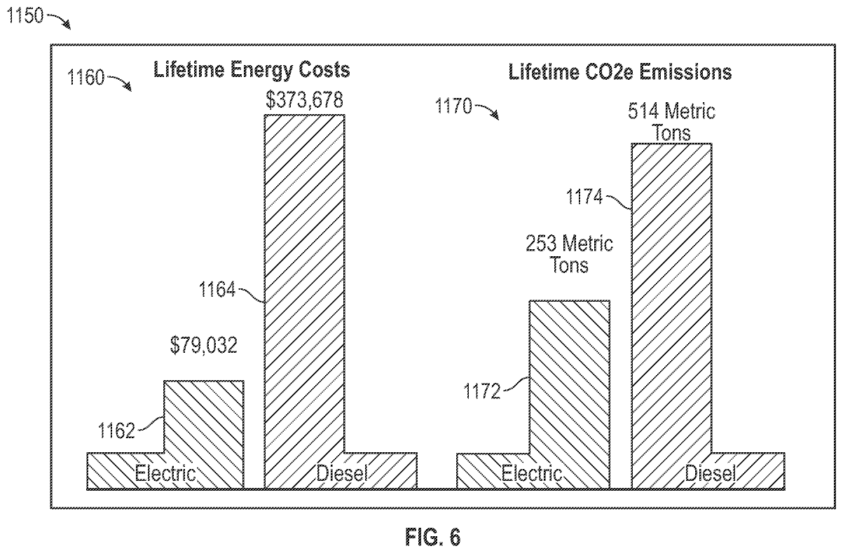

As shown in FIG. 6, the impact of ownership tool 1100 is configured to generate and provide a second graph output, shown as lifetime energy costs and CO₂e emissions graph 1150, based on the inputs and outputs of the vehicle model section 1102, the department response information section 1104, the cost section 1106, and/or the results section 1108. The lifetime energy costs and CO₂e emissions graph 1150 includes a first portion, shown as lifetime energy costs portion 1160, and a second portion, shown as lifetime CO₂e emissions portion 1170. The lifetime energy costs portion 1160 provides a first visual or graphical element, shown as lifetime electricity costs bar 1162, and a second visual or graphical element, shown as lifetime fuel costs bar 1164, that collectively facilitate comparing the projected lifetime electricity costs to operate the vehicle 10 and the projected lifetime fuel costs to operate an equivalent ICE variant of the vehicle 10. The lifetime CO₂e emissions portion 1170 provides a third visual or graphical element, shown as lifetime electricity CO₂e emissions bar 1172, and a fourth visual or graphical element, shown as lifetime fuel CO₂e emissions bar 1174, that collectively facilitate comparing the projected lifetime CO₂e emissions to operate the vehicle 10 and the projected lifetime CO₂e emissions to operate an equivalent ICE variant of the vehicle 10.

### Charger Sizing Tool

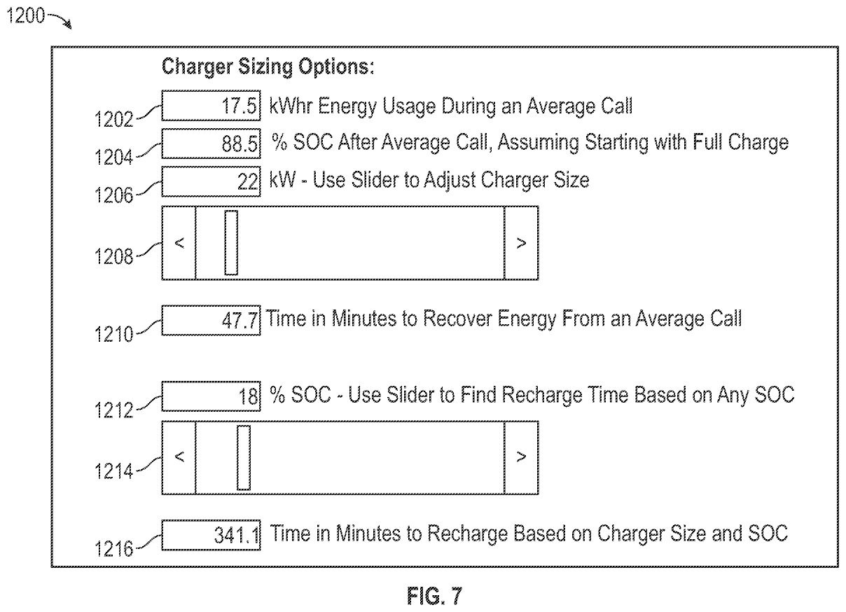

As shown in FIG. 7, the vehicle server 1020 (and/or the vehicle controller 800) is configured to facilitate accessing a second tool, shown as charger sizing tool 1200, with the user device 1050 and/or the user interface of the vehicle 10. According to an exemplary embodiment, the charger sizing tool 1200 facilitates evaluating charger sizes to identify a suitable charging station 930 for the vehicle 10 based on individual department needs (e.g., based on past history, based on desired performance, etc.). As shown in FIG. 7, the charger sizing tool 1200 includes a first input area, interface, or cell, shown as average energy usage box 1202, associated with an average energy usage (e.g., in kWhr) during an average call, response, or trip and a second input area, interface, or cell, shown as average post-call SOC box 1204, associated with an average SOC percentage of the ESS 700 following an average call, response, or trip. According to an exemplary embodiment, the charger sizing tool 1200 automatically populates information or data into the average energy usage box 1202 and the average post-call SOC box 1204 based on the information entered into or selected using the vehicle model section 1102, the department response information section 1104, and/or the cost section 1106 of the impact of ownership tool 1100.

As shown in FIG. 7, the charger sizing tool 1200 includes a third input area, interface, or cell, shown as charger size box 1206, that facilitates entering or selecting (e.g., from a drop-down menu) a size (e.g., in kW) of a charger for the vehicle 10 and a fourth input area, interface, or cell, shown as size slider 1208, that facilitates adjusting the value within the charger size box 1206 by selecting the left and right arrows thereof, or by manipulating the slider element thereof left and right. The charger sizing tool 1200 is configured to populate a first output area or cell, shown as recovery time box 1210, based on the values of the average energy usage box 1202, the average post-call SOC box 1204, and the charger size box 1206. The recovery time box 1210 provides a value indicating an amount of time it would take to recover the energy depleted from the ESS 700 during an average call with the vehicle 10 based on the current selected charger size. Accordingly, a user can evaluate which charger size is suitable to meet their specific needs based on average call response parameters and average dwell time at the station (i.e., time between response calls during which time the vehicle 10 can be recharged).

As shown in FIG. 7, the charger sizing tool 1200 includes a fifth input area, interface, or cell, shown as SOC box 1212, that facilitates entering or selecting (e.g., from a drop-down menu) a SOC value for the vehicle 10 of the user's choosing and a sixth input area, interface, or cell, shown as SOC slider 1214, that facilitates adjusting the value within the SOC box 1212 by selecting the left and right arrows thereof, or by manipulating the slider element thereof left and right. The charger sizing tool 1200 is configured to populate a second output area or cell, shown as recharge time box 1216, based on the values of the charger size box 1206 and the SOC box 1212. The recharge time box 1216 provides a value indicating an amount of time it would take to recharge the vehicle 10 based on the current selected charger size and the user selected SOC value. Accordingly, a user can evaluate which charger size is suitable to meet their specific needs (e.g., whether a higher output charger or a lower output charger is needed to meet needs).

### Cost of Ownership Optimization

According to an exemplary embodiment, the vehicle server 1020 (and/or the vehicle controller 800) is configured to provide charge management cost projections and functionality for the vehicle 10 to inform the user of potential cost saving opportunities if the charge management functionality were implemented and facilitate reducing operating costs for the vehicle 10 when the charge management functionality is implemented. Specifically, the vehicle server 1020 (and/or the vehicle controller 800) is configured to receive or acquire various inputs based on the vehicle data from the vehicle 10, the telematics data from the telematics system 1030 (e.g., regarding operation of the vehicle 10, other vehicles similar to the vehicle 10, etc.), the GPS data from the GPS 1040 (e.g., regarding operation of the vehicle 10, regarding operation of other vehicles within the same fleet or department, etc.), the user entered data from the user device 1050 and/or the user interface of the vehicle 10, and/or still other data from other sources (e.g., the EIA, the environmental protection agency (“EPA”), original equipment manufacturers (“OEMs”), etc.). Examples of such inputs are outlined in Table 1 and Table 2 below.

Table 1 outlines various vehicle specific inputs for the vehicle 10 acquired from one or more sources. The one or more sources may include the OEM for the vehicle 10, the EIA, the EPA, the telematics system 1030, and/or the GPS 1040. The vehicle specific inputs may include electric system efficiency, diesel system efficiency, annual electricity inflation rate, annual diesel inflation rate, energy per gallon of diesel, CO₂ emissions per gallon of diesel, CH₄ emissions per gallon of diesel, N₂O emissions per gallon of diesel, CO₂ equivalent emissions per CH₄ emissions, CO₂ equivalent emissions per N₂O emissions, average amount of fuel used per trip, average amount of electrical energy used per mile, average amount of idle energy consumption per trip, NOx emission per gallon of diesel, SO₂ emissions per gallon of diesel, battery capacity of the ESS 700, charging energy efficiency of the ESS 700, average amount of fuel used per moving time, average amount of idle energy consumption per trip, upper SOC limit for the batteries of the ESS 700, lower SOC limit for the batteries of the ESS 700, CO₂ equivalent emission per MWh of electric generation, NOx emissions per MWh of electric generation, SO₂ emissions per MWh of electric generation, and CO₂e emissions per gallon of diesel. It should be understood that the listed vehicle specific inputs are provided as examples, and additional, different, or fewer vehicle specific inputs may be used.

Table 2 outlines various department specific inputs for the vehicle 10 acquired from one or more sources. The one or more sources may include the departments power bill, the departments power agreement with their utilities provider, the EIA, the EPA, and the user and/or the telematics system 1030 (e.g., regarding operation of the vehicle 10, regarding operation of other vehicles within the same fleet or department, etc.). The department specific inputs may include maximum station power demand, monthly energy usage, whether weekends are charged at off-peak rates, off-peak energy rate, off-peak power rate using maximum draw, peak 1 energy rate, peak 1 power rate using maximum draw, start time of peak 1 rates, peak 2 energy rate, peak 2 power rate using maximum draw, start time of peak 2 rates, peak 3 energy rate, peak 3 power rate using maximum draw, start time of peak 3 rates, stop time of peak 3 rates, other fees and baseline charges, average distance for trips, longest distance for trips, average number of trips per day, a maximum number of trips in a day, number of the vehicles 10 at a respective station, excepted lifespan for the vehicle 10, deployment location for the vehicle 10, cost of diesel per gallon, CO₂ equivalent emissions per MWh of electric generation, off-peak AM charge rate, peak 1 charge rate, peak 2 charge rate, peak 3 charge rate, and off-peak PM charge rate. It should be understood that the listed department specific inputs are provided as examples, and additional, different, or fewer department specific inputs may be used.

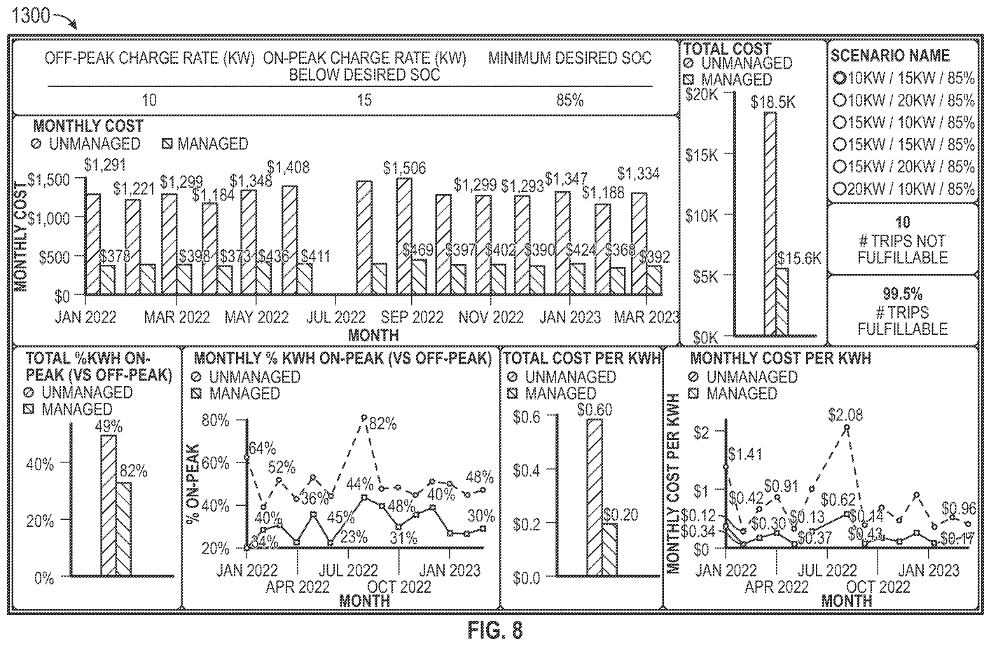

Based on the vehicle specific inputs and the department specific inputs, the vehicle server 1020 (and/or the vehicle controller 800) is configured to perform one or more methods or processes (e.g., using models, using probability distributions, using optimization tools, etc.) to generate various outputs regarding the charge management cost projections and the charge management functionality. More specifically, the charge management projections can inform users of proper charger sizing, energy costs, emissions, and optimization parameters, which are provided below in Tables 3 and 4, and shown in FIG. 8. The charge management functionality is described in greater detail below.

Table 3 outlines various per year outputs for the vehicle 10 generated by the vehicle server 1020 (and/or the vehicle controller 800) based on the vehicle specific inputs and the department specific inputs. The per year outputs may include a managed charging energy cost per year (i.e., a cost to charge the vehicle 10 if the charge management functionality in enabled), a fixed or unmanaged charging energy cost per year (i.e., a cost to charge the vehicle 10 if the charge management functionality is disabled), a fuel cost per year to operate an equivalent ICE variant of the vehicle 10, CO₂e savings per year relative to an equivalent ICE variant of the vehicle 10, a recommended charger size for the charging station 930, and a percentage of trips capable of being fulfilled over the year with the recommended charger size. It should be understood that the listed per year outputs are provided as examples, and additional, different, or fewer per year outputs may be generated.

Table 4 outlines various lifespan outputs for the vehicle 10 generated by the vehicle server 1020 (and/or the vehicle controller 800) based on the vehicle specific inputs and the department specific inputs. The lifespan outputs may include a total amount of electricity used by the vehicle 10, a total number of gallons of fuel used by the vehicle 10 (e.g., for pumping operations, for driving operations, etc.), a total number of gallons of fuel used by an equivalent ICE variant of the vehicle 10, a total amount of CO₂e emissions for the vehicle 10, a total amount of CO₂e emissions for an equivalent ICE variant of the vehicle 10, a total amount of NOx emissions for the vehicle 10, a total amount of NOx emissions for an equivalent ICE variant of the vehicle 10, a total amount of SO₂ emissions for the vehicle 10, a total amount of SO₂ emissions for an equivalent ICE variant of the vehicle 10, a total cost of operation for the vehicle 10, a total cost of operation for an equivalent ICE variant of the vehicle 10, a total amount of cost savings from operating the vehicle 10 relative to an equivalent ICE variant of the vehicle 10, a total amount of CO₂e savings from operating the vehicle 10 relative to an equivalent ICE variant of the vehicle 10, a total amount of SO₂ savings from operating the vehicle 10 relative to an equivalent ICE variant of the vehicle 10, and a total amount of NOx savings from operating the vehicle 10 relative to an equivalent ICE variant of the vehicle 10. It should be understood that the listed lifespan outputs are provided as examples, and additional, different, or fewer lifespan outputs may be generated.

TABLE 1
Vehicle Specific Inputs

| Value | Units | Description | Source |
|---|---|---|---|
| 80 | percent | Electric system efficiency | OEM |
| 27 | percent | Diesel system efficiency | OEM |
| 2.0 | percent | Annual electricity inflation rate (1994-2022) | EIA |
| 8.3 | percent | Annual diesel inflation rate (1994-2022) | EIA |
| 37.95 | kWh/gallon | Energy per gallon of diesel | EPA |
| 10.21 | kg CO2/gallon | CO2 emissions per gallon of diesel | EPA |
| 0.41 | g CH4/gallon | CH4 emissions per gallon of diesel | EPA |
| 0.60 | g N2O/gallon | N2O emissions per gallon of diesel | EPA |
| 25 | g CO2e/g CH4 | CO2 equivalent emissions per CH4 emissions | EPA |
| 298 | g CO2e/g N2O | CO2 equivalent emissions per N2O emissions | EPA |
| 0.02 | gal/trip | Average fuel used per trip | Telematics |
| 2.40 | kWh/mile | Average energy used per mile | Telematics |
| 1.12 | kWh/trip | Average idle energy consumption per trip | Telematics |
| 0.03 | kg NOx/gallon | NOx emissions per gallon of diesel | EPA DEQ |
| 0.05 | g SO2/gallon | SO2 emissions per gallon of diesel | EPA Limit |
| 155 | kWh | Vehicle battery capacity | OEM |
| 97 | percent | Charging energy efficiency | OEM |
| 0.02 | gal/min | Average fuel used per moving time | Telematics |
| 0.33 | kWh/trip | Average energy used per moving time | Telematics |
| 1.12 | kWh/trip | Average idle energy consumption per trip | Telematics |
| 96 | percent | Battery upper SOC limit | Telematics |
| 20 | percent | Battery lower SOC limit | Telematics |
| 390.2 | kg CO2e/MWh | CO2 equiv. emissions per MWh of electric generation | EPA |
| 0.2 | kg NOx/MWh | NOx emissions per MWh of electric generation | EPA |
| 0.3 | kg SO2/MWh | SO2 emissions per MWh of electric generation | EPA |
| 10.4 | kg CO2e/gallon | CO2e emissions per gallon of diesel | EPA |

TABLE 2
Department Specific Inputs

| Value | Units | Description | Source |
|---|---|---|---|
| 40 | kW | Maximum station power demand | Power bill |
| 10000 | kWh | Monthly energy usage | Power bill |
| False | true/false | Weekend is off-peak | Power agreement |
| 0.09 | $/kWh | Off-peak energy rate | Power agreement |
| 0.08 | $/kWh/day | Off-peak power rate w/maximum power draw | Power agreement |
| 0.11 | $/kWh | Peak 1 energy rate | Power agreement |
| 0.10 | $/kWh/day | Peak 1 power rate using maximum draw | Power agreement |
| 0.11 | $/kWh | Peak 2 energy rate | Power agreement |
| 0.10 | $/kWh/day | Peak 2 power rate using maximum draw | Power agreement |
| 0.11 | $/kWh | Peak 3 energy rate | Power agreement |
| 0.20 | $/kWh/day | Peak 4 power rate using maximum draw | Power agreement |
| 180.00 | $/month | Other fees & baseline charge | Power agreement |
| 10:00 | time | Start of peak 1 rates | Power agreement |
| 13:00 | time | Start of peak 2 rates | Power agreement |
| 18:00 | time | Start of peak 3 rates | Power agreement |
| 21:00 | time | Stop of peak 3 rates | Power agreement |
| 8.0 | miles | Normal trips are 0 to | Department |
| 30.0 | miles | The longest emergency trip is | Department |
| 9.0 | calls | Normal days have 0 to | Department |
| 30.0 | calls | A rare busy day has | Department |
| 1.0 | trucks | Number of station electric trucks | Department |
| 12 | years | Expected lifespan of vehicle | Department |
| U.S. | region | Vehicle deployment location | Department |
| 4.69 | $/gallon | Cost of diesel per gallon | EIA/Department |
| 390.2 | kg CO2e/MWh | CO2e emissions per MWh of elec. generation | EPA |
| 20.5 | kW | Off-peak AM charge rate | Dept. or Optimized |
| 0.0 | kW | Peak 1 charge rate | Dept. or Optimized |
| 0.0 | kW | Peak 2 charge rate | Dept. or Optimized |
| 0.0 | kW | Peak 3 charge rate | Dept. or Optimized |
| 20.2 | kW | Off-peak PM charge rate | Dept. or Optimized |
| 45.0 | kW | unmanaged | Calculated |

TABLE 3
Per Year Outputs

| Value | Units | Description | Source |
|---|---|---|---|
| 4200 | $ | Managed charging energy cost per year | Calculated |
| 11900 | $ | Fixed charge rate energy cost per year | Calculated |
| 12500 | $ | Traditional diesel fire apparatus cost | Calculated |
| | | per year | |
| 13200 | kg | CO2e savings vs diesel fire apparatus | Calculated |
| | | per year | |
| 55 | kW | Recommended charger size | Calculated |
| 99.7 | percent | Trips fulfilled with recommended charger | Calculated |
| | | size | |

TABLE 4
Lifespan Outputs

| Value | Units | Description | Source |
|---|---|---|---|
| 408135 | kWh/lifespan | kWh of electricity used by e-fire apparatus over lifespan | Calculated |
| 1560 | gal/lifespan | Gallons of diesel used for pumping over lifespan | Calculated |
| 33426 | gal/lifespan | Gallons of diesel used for diesel equivalent over lifespan | Calculated |
| 172396 | kg CO2e | Over e-fire apparatus' lifespan | Calculated |
| 147 | kg NOx | Over e-fire apparatus' lifespan | Calculated |
| 196 | kg SO2 | Over e-fire apparatus' lifespan | Calculated |
| 331369 | kg CO2e | Over diesel fire apparatus' lifespan | Calculated |
| 10891 | kg NOx | Over diesel fire apparatus' lifespan | Calculated |
| 2 | kg SO2 | Over diesel fire apparatus' lifespan | Calculated |
| 50400 | $/lifespan | Over e-fire apparatus' lifespan | Calculated |
| 150000 | $/lifespan | Over diesel fire apparatus' lifespan | Calculated |
| 99600 | $ saved | Electric vs diesel fuel savings over lifespan | Calculated |
| 158973 | kg CO2e saved | Electric vs diesel CO2e emissions over lifespan | Calculated |
| −195 | kg SO2 saved | Electric vs diesel SO2 emissions over lifespan | Calculated |
| 10744 | kg NOx saved | Electric vs diesel NOx emissions over lifespan | Calculated |

As shown in FIG. 8, the vehicle server 1020 (and/or the vehicle controller 800) is configured to provide or facilitate accessing a third tool, shown as charge management tool 1300. The charge management tool 1300 is configured to provide a graphical user interface displaying various statistics for comparing parameters when the charge management functionality in disabled versus when the charge management functionality is enabled. The parameters include monthly charging costs, total/lifetime charging costs, monthly percent of on-peak versus off-peak charging, monthly cost per kWh, and total/lifetime cost per kWh. The charge management functionality is described in greater detail herein.

### Dynamic Charge Management

According to an exemplary embodiment, the vehicle server 1020 (and/or the vehicle controller 800) is configured to provide the charge management functionality to make dynamic charging decisions regarding each of the vehicles 10 within a respective vehicle fleet 900 that are connected to the charging stations 930. Such dynamic charging decisions may be implemented based on the above cost of ownership optimization and if the user has such functionality enabled.

According to an exemplary embodiment, the vehicle server 1020 (and/or the vehicle controller 800) is configured to receive an indication of vehicles 10 within a respective vehicle fleet 900 connected to the charging stations 930 (e.g., from the charging stations 930) and determine a charge readiness score for each of the vehicles 10 that are charging or attempting to be charged via a respective charging station 930 based on the vehicle data, the telematics data, the GPS data, and/or the user entered data. The charge readiness score may be based on one or more factors including (a) a vehicle response history profile of a respective vehicle 10, (b) a station response history profile of a station or location at which the respective vehicle 10 is charging or attempting to be charged with a respective charging station 930, (c) a current cost of electricity at the location at which the respective vehicle 10 is charging or attempting to be charged, (d) an expected future cost of electricity at the location at which the respective vehicle 10 is charging or attempting to be charged, include a current SOC of the respective vehicle 10, and/or (f) a current SOC of other vehicles 10 charging or attempting to be charged at the same location of the respective vehicle 10, among other suitable factors.

The vehicle response history profile may indicate how often a respective vehicle 10 is dispatched to a response scene, at what times the respective vehicle 10 is typically dispatched to a response scene, how far the respective vehicle 10 typically has to travel to get to a response scene, battery depletion patterns for the respective vehicle 10, and/or any other trends regarding the respective vehicle 10. The station response history profile may indicate how often the vehicles 10 stationed at a respective station are dispatched to a response scene, at what times the vehicles 10 stationed at the respective station are typically dispatched to a response scene, how far the vehicles 10 stationed at the respective station typically have to travel to get to a response scene, battery depletion patterns for the vehicles 10 stationed at the respective station, and/or any other trends regarding the vehicles 10 stationed at the respective station. The expected future cost of electricity may be based on (a) the current time, date, and/or weather/temperature conditions and (b) past cost history during similar times (e.g., season, month, day, time of the day, etc.), during similar weather and temperature conditions (e.g., snow, rain, sunny, severe cold, extreme heat, etc.), etc.

Generally, after determining the charge readiness score for each of the vehicles 10 within a respective vehicle fleet 900 and/or at a respective location (e.g., the location 910, the location 920, etc.), the vehicle server 1020 (and/or the vehicle controller 800) may be configured to dynamically charge the vehicles 10 within the respective vehicle fleet 900 and/or at the respective location. For example, the vehicle server 1020 (and/or the vehicle controller 800) may prevent charging of a first vehicle 10 in favor of a second vehicle 10. As another example, the vehicle server 1020 (and/or the vehicle controller 800) may prevent charging of a respective vehicle 10 based on expected demand of that vehicle and current electricity costs. As yet another example, the vehicle server 1020 may prevent charging a respective vehicle 10 if the charge readiness score is below a charge readiness threshold. These and other examples are further described herein.

A charge readiness score for a respective vehicle 10 may be lowered or reduced based on (a) the current cost of electricity being higher than the expected cost of electricity later that day or night, (b) it currently being unlikely that the respective vehicle 10 will need to be dispatched to a response scene (e.g., based on the vehicle response history profile, the station response history profile, etc.), (c) another vehicle 10 at the same station having a relatively high or higher SOC (e.g., such that the other vehicle 10 is sufficient to respond to an upcoming dispatch call), and/or (d) the respective vehicle 10 having a relatively high SOC (e.g., such that the respective vehicle 10 can respond to an upcoming dispatch call without requiring charging), among other possible factors. Whereas, a charge readiness score for a respective vehicle 10 may be increased or higher based on (a) the current cost of electricity being lower than the expected cost of electricity later that day or night, (b) it currently being likely that the respective vehicle 10 will need to be dispatched to a response scene (e.g., based on the vehicle response history profile, the station response history profile, etc.), (c) another vehicle 10 at the same station having a relatively low or lower SOC (e.g., such that the other vehicle 10 is sufficient to respond to an upcoming dispatch call) or no other vehicle 10 being stationed at the location of the respective vehicle 10, and/or (d) the respective vehicle 10 having a relatively low SOC (e.g., such that the respective vehicle 10 may not be able to properly respond to an upcoming dispatch call without being charged), among other possible factors.

Further, the charge readiness score for a respective vehicle 10 may be different depending on the station at which the respective vehicle 10 is currently stationed, all other things considered equal. For example, under the same conditions (e.g., cost of electricity, current SOC, etc.), one station may historically be more active than another station such that moving the respective vehicle 10 from one station to another may significantly impact how charging of that vehicle 10 is handled by the vehicle server 1020 (and/or the vehicle controller 800).

After determining the charge readiness score for a respective vehicle 10 that is plugged into or attempting to be plugged into a respective charging station 930, the vehicle server 1020 (and/or the vehicle controller 800) may be configured to send a signal to the respective vehicle 10 (or the respective charging station 930) to either prevent charging from starting, stop charging if already charging, start charging if not already charging, or continue charging if already charging. As an example, if a first vehicle 10 is already charging and a second vehicle 10 is subsequently plugged in, the vehicle server 1020 (and/or the vehicle controller 800) (and/or the vehicle controller 800) may determine whether the first vehicle 10 should continue charging or stop charging based on the second vehicle 10 being plugged in. As another example, the current price of electricity may shift during charging such that the vehicle server 1020 (and/or the vehicle controller 800) may determine whether the first vehicle 10 should continue charging or stop charging based on the shift in price. As yet another example, a first vehicle 10 that is currently charging may be dispatched to a scene, and as such, the charge readiness score for a second vehicle 10 may shift higher due to the likelihood of having to now be dispatched. In such a scenario, the vehicle server 1020 (and/or the vehicle controller 800) may determine whether to start charging the second vehicle 10 or continue not charging the second vehicle 10.

In some embodiments, the vehicle server 1020, the vehicle controller 800 of a respective vehicle 10, and/or a respective charging station 930 provide an indication of whether charging is occurring or currently suspended or prevented. In some embodiments, an operator (e.g., at the location at which the charging is being attempted for the respective vehicle 10) may be able to override the suspension in charging (e.g., via a user interface of the respective vehicle 10, via a user interface of the respective charging station 930, via a user device (a smart phone, a computer, etc.) in communication with the vehicle server 1020, etc.). In some embodiments, if connection to the vehicle server 1020 is lost, the respective charging station 930 and/or the vehicle controller 800 of the respective vehicle 10 may be configured to default to permitting charging. In some embodiments, if connection to the vehicle server 1020 is lost, the vehicle controller 800 of the respective vehicle 10 makes the charging decision based on the information available to it. In some embodiments, the vehicle server 1020 (and/or the vehicle controller 800) is configured to permit a respective vehicle 10 to be charged to a certain SOC threshold (e.g., a predefined threshold, a dynamic threshold based on the vehicle response history profile and the station response history profile, etc.) and then suspend charging once the certain SOC threshold is reached and then permit charging later on when electricity prices have dropped.

Accordingly, the vehicle evaluation, charging, and optimization system 1000 is configured to maintain a respective vehicle 10, a respective fire station (e.g., having multiple vehicles 10), and/or an entire respective vehicle fleet 900 ready for dispatch calls, but doing so in a manner that reduces the operating costs to keep the vehicles 10 charged and ready to be dispatched.

### Other Functionality

According to an exemplary embodiment, the various charging related functionality described herein can be applied to other subsystems of the vehicle 10 such as the pump system 600 and/or the aerial ladder 50. By way of example, the vehicle server 1020 and/or the vehicle controller 800 may provide a pump tool configured to store pump curves for the pump system 600 and receive or acquire pump inputs including type of pump, net inlet pump pressure value (e.g., positive pressure value from hydrant, negative pressure value from a ground based tank, a net zero pressure from an onboard tank, etc.), and a desired or required output flow value. Based on the pump curves and the pump inputs, the pump tool may be configured to calculate electric energy consumption and a burn down rate of stored, onboard energy to provide the desired output flow. Such a pump tool may be used with the user device 1050 when configuring the vehicle 10 pre-manufacture so that the selected pump can meet specific needs of a respective department. Such a pump tool may additionally or alternatively be used in real-time during pumping at a scene to provide real-time energy usage and depletion on the user interface of the vehicle 10 (e.g., an in-cab interface, a pump house display, etc.).

By way of another example, the vehicle server 1020 and/or the vehicle controller 800 may provide an aerial ladder tool configured to store a load curve for the aerial ladder 50 and monitor ladder operation data (e.g., position, extension, retraction, rotation, lift, etc.) regarding operation of the aerial ladder 50. Based on the load curve and the ladder operation data, the aerial ladder tool may be configured to calculate electric energy consumption and a burn down rate of stored, onboard energy to continue operating the actuators of the aerial ladder 50 (e.g., hydraulic pump driven by an electric motor, driven by an ePTO, etc.) to provide the current operation of the aerial ladder. Such an aerial ladder tool may be used in real-time during aerial operation at a scene to provide real-time energy usage and depletion on the user interface of the vehicle 10 (e.g., an in-cab interface, an interface on the aerial ladder, etc.).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein.

1. A charge management system comprising:
one or more processing circuits including one or more memory devices coupled to one or more processors, the one or more memory devices configured to store instructions thereon that, when executed by the one or more processors, cause the one or more processors to:
receive an indication regarding an electrified fire apparatus being connected to a charging station;
determine a charge readiness score for the electrified fire apparatus; and
provide a charge management function by transmitting a signal to at least one of the charging station or the electrified fire apparatus to prevent charging from starting, stop charging if already charging, start charging if not already charging, or continue charging if already charging based on the charge readiness score.

2. The charge management system of claim 1, wherein the charge readiness score is based on at least one of (a) a response history profile of the electrified fire apparatus, (b) a fire station response history profile of a fire station at which the charging station is located, (c) a current cost of electricity at a location of the charging station, (d) an expected future cost of electricity at the location of the charging station, (e) a current state of charge of the electrified fire apparatus, or (f) a current state of charge of another electrified fire apparatus charging or attempting to be charged at the fire station.

3. The charge management system of claim 2, wherein the charge readiness score is based on at least the response history profile of the electrified fire apparatus, and wherein the response history profile indicates at least one of (a) how often the electrified fire apparatus is dispatched from the fire station to a response scene, (b) at what times the electrified fire apparatus is typically dispatched to a response scene, (c) how far the electrified fire apparatus typically has to travel to get to a response scene, or (d) battery depletion patterns for the electrified fire apparatus.

4. The charge management system of claim 2, wherein the charge readiness score is based on at least the fire station response history profile, and wherein the fire station response history profile indicates at least one of (a) how often one or more vehicles stationed at the fire station are dispatched to a response scene, (b) at what times the one or more vehicles stationed at the fire station are typically dispatched to a response scene, (c) how far the one or more vehicles stationed at the fire station typically have to travel to get to a response scene, or (d) battery depletion patterns for one or more electrified fire apparatuses stationed at the respective station,

5. The charge management system of claim 2, wherein the charge readiness score is based on at least the current price of electricity at the location of the charging station and the expected future price of electricity at the location.

6. The charge management system of claim 1, wherein the electrified fire apparatus is a first electrified fire apparatus and the charging station is a first charging station, and wherein, if the first electrified fire apparatus is being charged with the first charging station and a second electrified fire apparatus is subsequently plugged into a second charging station at the same location as the first charging station, the instructions cause the one or more processors to:
determine an updated charge readiness score based on the second electrified fire apparatus being plugged into the second charging station; and
determine whether the first electrified fire apparatus should continue charging or stop charging based on the updated charge readiness score.

7. The charge management system of claim 1, wherein the instructions cause the one or more processors to adjust the charge readiness score in response to a price of electricity changing while at least one of (a) the electrified fire apparatus is plugged into the charging station or (b) the electrified fire apparatus is being charged by the charging station.

8. The charge management system of claim 1, wherein the electrified fire apparatus is a first electrified fire apparatus, the charging station is a first charging station, the charge readiness score is a first charge readiness score, and the signal is a first signal, and wherein the instructions cause the one or more processors to:
determine a second charge readiness score for the second electrified apparatus plugged into a second charging station at the same location of the first charging
determine an updated second charge readiness score for the second electrified fire apparatus plugged into the second charging station in response to the first electrified fire apparatus being dispatched to a scene; and
transmit a second signal to at least one of the second charging station or the second electrified fire apparatus to prevent charging from starting, start charging if not already charging, or continue charging if already charging based on the updated second charge readiness score.

9. The charge management system of claim 1, wherein the instructions cause the one or more processors to receive an override command from an operator of the electrified fire apparatus if the signal prevents charging from starting or stops charging if already charging.

10. The charge management system of claim 1, wherein at least one of the one or more processing circuits includes a processing circuit of a server, and wherein the at least one of the charging station or the electrified fire apparatus is configured to default to permitting charging in response to connection to the server being lost.

11. The charge management system of claim 1, wherein the electrified fire fighting apparatus is configured to be associated with a respective fire station, wherein the instructions cause the one or more processors to maintain the respective fire station including one or more electrified vehicles including at least the electrified fire apparatus ready for dispatch calls while reducing operating costs to keep the one or more electrified vehicles sufficiently charged and ready to be dispatched.

12. The charge management system of claim 1, wherein the instructions cause the one or more processors to provide a graphical user interface that compares one or more parameters when the charge management function is enabled versus disabled.

13. The charge management system of claim 12, wherein the one or more parameters include at least one of monthly charging costs, total charging costs, monthly percent of on-peak versus off-peak charging, monthly cost per kWh, or total cost per kWh.

14. A charge management system comprising:
one or more processing circuits including one or more memory devices coupled to one or more processors, the one or more memory devices configured to store instructions thereon that, when executed by the one or more processors, cause the one or more processors to:
receive indications regarding one or more electrified fire apparatuses associated with a fire station being connected to one or more charging stations at the fire station; and
maintain the one or more electrified fire apparatuses sufficiently charged and ready to be dispatched while reducing operating costs for the fire station.

15. The charge management system of claim 14, wherein the instructions cause the one or more processors to:
determine a charge readiness score for each of the one or more electrified fire apparatuses; and
provide a charge management function by transmitting signals to at least one of the one or more charging stations or the one or more electrified fire apparatuses to prevent charging from starting, stop charging if already charging, start charging if not already charging, or continue charging if already charging based on the charge readiness score.

16. The charge management system of claim 14, wherein the instructions cause the one or more processors to prevent a respective electrified fire apparatus from charging in response to (a) a state of charge of the respective electrified fire apparatus being greater than a charge threshold and (b) a current price of electricity being greater than an expected future price of electricity.

17. The charge management system of claim 14, wherein, if a first electrified fire apparatus of the one or more electrified fire apparatuses is being charged with a first charging station of the one or more charging stations and a second electrified fire apparatus of the one or more electrified fire apparatuses is subsequently connected to a second charging station of the one or more charging stations, the instructions cause the one or more processors to:
determine whether the first electrified fire apparatus should continue charging or stop charging based on the second electrified fire apparatus being connected to the second charging station; and
determine whether the second electrified fire apparatus should start charging or be prevented from charging.

18. The charge management system of claim 14, wherein, if a first electrified fire apparatus of the one or more electrified fire apparatuses is connected to and being charged with a first charging station of the one or more charging stations and a second electrified fire apparatus of the one or more electrified fire apparatuses is connected to but not being charged with a second charging station of the one or more charging stations, the instructions cause the one or more processors to transmit a signal to at least one of the second charging station or the second electrified fire apparatus to prevent charging from starting or start charging in response to the first electrified vehicle at least one of being disconnected from the first charging station or dispatched to a scene.

19. A charge management system comprising:
one or more processing circuits including one or more memory devices coupled to one or more processors, the one or more memory devices configured to store instructions thereon that, when executed by the one or more processors, cause the one or more processors to:
receive a first indication regarding a first electrified fire apparatus being connected to a first charging station at a fire station;
receive a second indication regarding a second electrified fire apparatus being connected to a second charging station at the fire station; and
provide a charge management function by (a) transmitting a first signal to at least one of the first charging station or the first electrified fire apparatus and (b) transmitting a second signal to at least one of the second charging station or the second electrified fire apparatus;
wherein each of the first signal and the second signal either prevents charging from starting, stops charging if already charging, starts charging if not already charging, or continues charging if already charging; and
wherein the first signal and the second signal are based on (a) a fire station response history profile for the fire station, (b) a current cost of electricity at the fire station, (c) an expected future cost of electricity at the fire station, (d) a first current state of charge of the first electrified fire apparatus, and (e) a second current state of charge of the second electrified fire apparatus.

20. The charge management system of claim 19, wherein the instructions cause the one or more processors to provide a graphical user interface that compares one or more parameters when the charge management function is enabled versus disabled, and wherein the one or more parameters include at least one of monthly charging costs, total charging costs, monthly percent of on-peak versus off-peak charging, monthly cost per kWh, or total cost per kWh.
